(19) United States
(12) Patent Application Publication
(10) Pub. No.: US 2026/0010430 A1
(43) Pub. Date: Jan. 8, 2026

(54) BIT SPREADING TECHNIQUE FOR RADIATION HARDENED ERROR RESISTANT MEMORY SYSTEM

(71) Applicant: BAE SYSTEMS Information and Electronic Systems Integration Inc., Nashua, NH (US)

(72) Inventors: David D. Moser, Haymarket, VA (US); Jason F. Ross, Haymarket, VA (US); Mark R. Shaffer, Virginia Beach, VA (US); Michael Brown, Spotsylvania, VA (US); Daniel L. Stanley, Warrenton, VA (US); Jeffrey Robertson, Ashburn, VA (US)

(73) Assignee: BAE SYSTEMS Information and Electronic Systems Integration Inc., Nashua, NH (US)

(21) Appl. No.: 18/303,933

(22) Filed: Apr. 20, 2023

(51) Int. Cl. G06F 11/10

(52) U.S. Cl. CPC G06F 11/1004

(57) ABSTRACT

Techniques are provided for an error resistant radiation hardened memory system based on spreading of data bits among multiple random access memories (RAMs). A memory system implementing the techniques according to an embodiment includes a first plurality of RAMs configured to store data bits written to the memory system, the data bits distributed over the first plurality of RAMs. The system also includes an error correction coding (ECC) circuit configured to generate ECC codes, each of the codes associated with a unique group of the data bits. The system further includes a second plurality of RAMs configured to store bits of the ECC codes such that the bits of each ECC code are distributed over the second plurality of RAMs. The system further includes a reporting circuit configured to report a single bit error correction or a double bit error detection, resulting from a read operation on the memory system.

### STATEMENT OF GOVERNMENT INTEREST

This invention was made with United States Government assistance under Contract No. 100115865, awarded by the National Security Technology Accelerator agency. The United States Government has certain rights in this invention.

### FIELD OF DISCLOSURE

The present disclosure relates to memory systems, and more particularly to the use of bit spreading techniques in a memory system to provide radiation hardened memory operation to reduce radiation induced single event effect susceptibility.

### BACKGROUND

Memory systems deployed in space-based applications are subjected to relatively high radiation levels which can cause a significant increase in single-bit, multi-bit, and single event functional interrupt (SEFI) errors in which an entire memory is corrupted. In some cases, these errors can render the memory non-functional. Shielding can reduce the radiation exposure, but this approach is impractical due to the added weight (e.g., requiring lead or similarly dense materials), particularly in space-based applications where stringent weight constraints may be imposed. Redundant memories that use majority voting techniques can reduce error rates, but this approach also increases cost and complexity to a degree that may not be practical in many applications. Error correction coding (ECC) schemes exist, but these also have limitations.

### BRIEF DESCRIPTION OF THE DRAWINGS

FIG. 1 illustrates an implementation of a radiation hardened error resistant memory system, in accordance with certain embodiments of the present disclosure.

FIG. 2 is a block diagram of the error resistant memory system of FIG. 1, configured in accordance with certain embodiments of the present disclosure.

FIG. 3 is an illustration of a bit spreading memory unit configured for eight bit data words, in accordance with certain embodiments of the present disclosure.

FIG. 4 is an illustration of a bit spreading memory unit configured for 16 bit data words, in accordance with certain embodiments of the present disclosure.

FIG. 5 is an illustration of a bit spreading memory unit configured for 32 bit data words, in accordance with certain embodiments of the present disclosure.

FIG. 6 is an illustration of a bit spreading memory unit configured for 64 bit data words, in accordance with certain embodiments of the present disclosure.

FIG. 7 is an illustration of a bit spreading memory unit configured for 128 bit data words, in accordance with certain embodiments of the present disclosure.

FIG. 8 is a flowchart illustrating a methodology for providing radiation hardened error resistant memory, in accordance with an embodiment of the present disclosure.

FIG. 9 is a block diagram of a processing platform configured to provide radiation hardened error resistant memory, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for an error resistant memory system configured to provide radiation hardened memory operation, for example, to reduce radiation induced single event effect susceptibility in which a single radiation event can corrupt multiple bits or an entire Random Access Memory (RAM). The techniques are based on the spreading of data bits over multiple RAMs. As noted above, memory systems deployed in space-based applications are subjected to relatively high radiation levels which can cause a significant increase in single-bit, multi-bit, and SEFI errors. In some cases, these errors can render the memory non-functional. As memory circuits become smaller, less radiation energy is required to flip a bit from a one to a zero or vice versa. Shielding can reduce the radiation exposure, but this approach is impractical due to the added weight (e.g., requiring lead or similarly dense materials), particularly in space-based or aerospace applications where stringent weight constraints may be imposed. Redundant memories that use majority voting techniques can reduce error rates, but this approach also increases cost and complexity to a degree that may not be practical in some applications. ECC schemes also have limitations, particularly when data bits are stored within a single RAM which is susceptible to multi-bit and SEFI errors from a single radiation event.

To this end, and in accordance with an embodiment of the present disclosure, an error resistant memory system is disclosed which accepts a data word to be written to the memory system and distributes, or spreads, the data bits of that word, along with associated error correction codes, for storage over a number of separated RAMs. This bit spreading technique allows for successful error recovery if a single RAM is subject to radiation levels (or interference from other sources) that change the value of one or more bits of that RAM. Because the RAMs are physically separated from each other to some extent, it is less likely that a single radiation particle will impact more than one RAM at a time. Additionally, by providing error protection on a word basis, as opposed to protection on a larger block basis, any failures in the error protection do not incur the greater latency that would result from recovering the data in a larger block. As such, a RAM can fail, and the pipeline of data being read will not be subjected to gaps of empty read cycles.

The error resistant memory system provides improved reliability for memory operation in higher radiation environments such as space-based applications. The disclosed error resistant memory system can be used, for instance, with electronic systems in a wide variety of applications including, for example, radar systems and communication systems that can be deployed in space-based applications (e.g., satellite-based platform) or other high radiation environments, although other applications, including aerospace and terrestrial applications such as automotive products, will be apparent.

In accordance with an embodiment, the error resistant memory system includes one or more memory units, wherein each memory unit is configured to store a data word written to the memory system. Each memory unit comprises a first plurality of RAMs configured to store data bits of the data word such that the data bits are distributed over the first plurality of RAMs. The memory system also includes an ECC circuit configured to generate ECC codes, each of the ECC codes associated with a unique group of the data bits. Each memory unit further includes a second plurality of RAMs configured to store bits of the ECC codes such that the bits of the ECC codes are distributed over the second plurality of RAMs. The memory system further includes a reporting circuit configured to report a single bit error correction or a double bit error detection, resulting, for example, from a read operation on the memory unit.

It will be appreciated that the techniques described herein may provide improved error correction and recovery capabilities, in terms of cost, reliability, and operational speed, compared to systems that provide physical shielding or that require redundant storage. Numerous embodiments and applications will be apparent in light of this disclosure.

### System Architecture

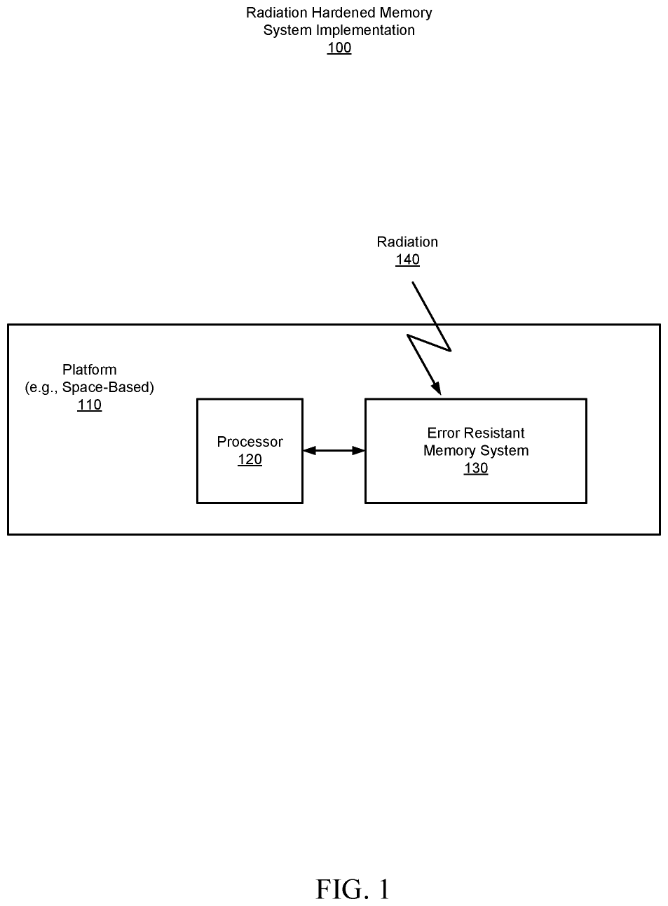

FIG. 1 illustrates an implementation 100 of a radiation hardened error resistant memory system, in accordance with certain embodiments of the present disclosure. The implementation 100 is shown to include a processor 120 and an error resistant memory system 130, hosted on a platform 110. In some embodiments, the platform 110 is a space-based or aerospace platform that can be subject to radiation 140 at greater levels of intensity compared to earth-based platforms. Other applications include those that may operate in environments with high levels of ionizing radiation such as military and nuclear applications.

The operation of the error resistant memory system 130 will be described in greater detail below, but at a high level, error resistant memory system 130 is configured to detect and correct errors (e.g., errors caused by radiation effects or from other sources). In some embodiments, the error resistant memory system 130 employs ECC codes that are associated with a group of data bits and that can correct a single bit error that occurs within that group of data bits. The ECC codes can also detect, but not necessarily correct, a double bit error within the group of data bits. The error resistant memory system provides improved resilience to errors by distributing the groups of data bits and associated ECC codes over a number of separate RAMs, such that bit errors in any one of the RAMs, or even a failure of an entire single RAM, can be corrected, as will be explained below.

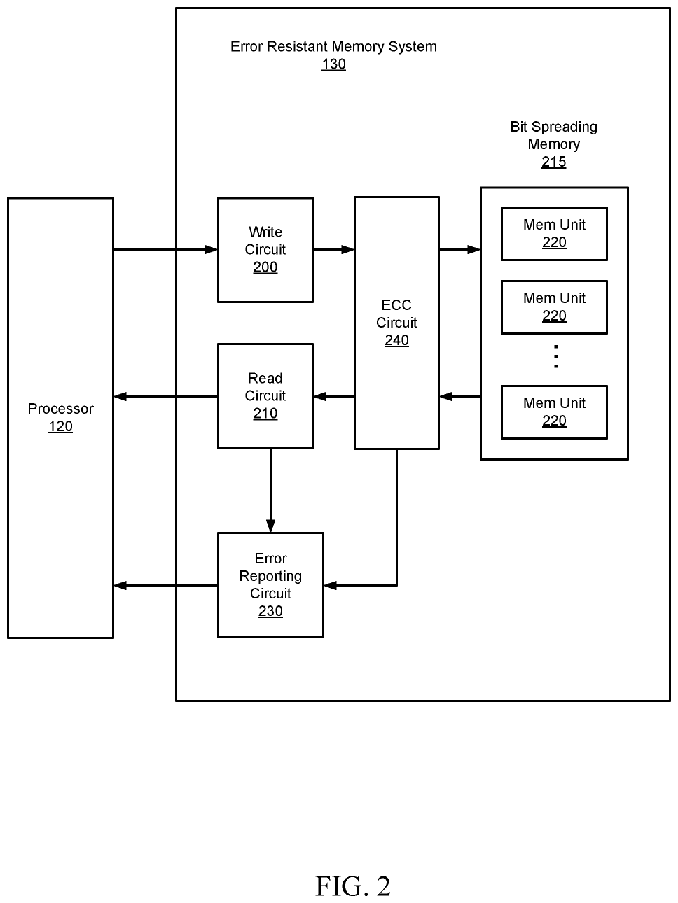

FIG. 2 is a block diagram of the error resistant memory system 130 of FIG. 1, configured in accordance with certain embodiments of the present disclosure. The error resistant memory system 130 is shown to include a memory write circuit 200, a memory read circuit 210, a bit spreading memory 215 (comprising a number of bit spreading memory units 220), an error reporting circuit 230, and an ECC circuit 240.

The memory write circuit 200 is configured to accept data words from the processor 120, or any other suitable source, and write them to the bit spreading memory 215. The data words may be of any desired bit length. In some embodiments, for example, the data words may be 8 bits, 16 bits, 32 bits, 64 bits, or 128 bits, although other lengths are possible including lengths that are not necessarily a power of 2.

The memory read circuit 210 is configured to read data words from the bit spreading memory 215, for example at the request of the processor, and provide those data words back to the processor or any other suitable destination.

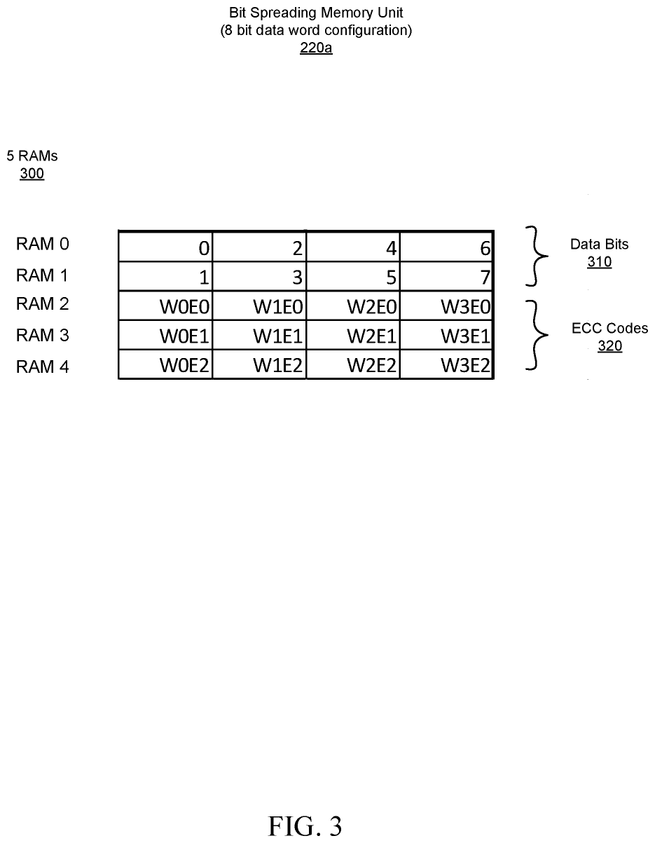

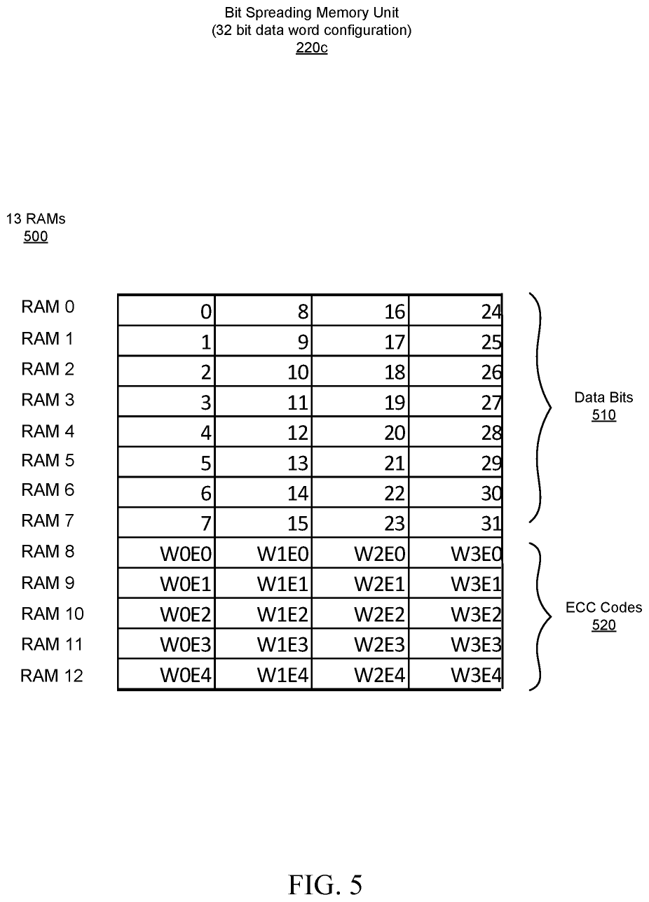

The bit spreading memory 215 comprises a number of bit spreading memory units 220. In some embodiments, each of the memory units 220 is configured to store a data word. A memory unit may be selected by an address that accompanies a memory write operation or a memory read operation. The address thus specifies which memory unit 220, of the memory 215, the data word is to be written to or read from. The memory units 220 are configured to store a data word in an error resistant manner by distributing data bits of the data word, along with an ECC code, over a number of separate RAMs in the memory unit. In some embodiments, the RAMs may be configured to store more than one data word and the multiple words may be selectable by addresses. The operation of memory units of varying sizes is described in greater detail below in connection with FIGS. 3 through 7, but looking at FIG. 5, for example, a 32 bit data word is broken up into 4 groups of data bits (e.g., bits 0-7, 8-15, 16-23, and 24-31) and each data group is spread over 8 RAMs (RAMS 0-7). As also shown in FIG. 5, an ECC code associated with each data group is spread over 5 additional RAMs (e.g., W0, W1, W2, W3 and W4 over RAMs 8-12).

The size of the memory 215 can be configured based on the memory requirements of the application (e.g., mission software running on the processor 120) or on any other suitable considerations. For example, if a 1K memory of 32 bit data words is required, then the memory 215 can comprise 1K memory units 220, each configured to store 32 bit data words. As previously noted, in some embodiments, each RAM may be configured to store multiple words, so the number of memory units may be reduced accordingly. For example, if the RAMs were configured to store 16 words, then only 64 memory units (e.g., 1024/16) would be needed.

The ECC circuit 240 is configured to generate ECC codes for each of the groups of data bits, for example when a data word is written to the memory unit. In some embodiments, the ECC codes are configured to detect and correct a single bit error in the group of data bits, and to detect a double bit error in the group of data bits. In some embodiments, the ECC code may be a Hamming code, although other suitable single bit error correction codes may be used, in light of the present disclosure. In some embodiments, the ECC codes are of length M bits, where M=log₂(N)+2 bits, where N is the number of bits in the data group for which the ECC code is being generated.

The ECC circuit 240 is also configured to use the ECC codes to detect and possibly correct errors in each of the groups of data bits, for example when a data word is read from the memory unit.

The error reporting circuit 230 is configured to report any single bit error corrections or double bit error detections that occur. In some embodiments, the reporting may be directed back to the processor which may use the information to track the error rates and take any appropriate action.

FIG. 3 is an illustration of a bit spreading memory unit 220a configured for eight bit data words, in accordance with certain embodiments of the present disclosure. The memory unit 220a is shown to include five RAMs 300, each configured to store four bits. The first two RAMs are configured to store the eight data bits 310 of the data word written to the memory unit, as shown. In particular, a first group of data bits (0, 1) are stored or distributed over RAMs 0 and 1 in the first column of the RAMs. Likewise, a second group of data bits (2, 3) are stored in the second column, a third group of data bits (4, 5) are stored in the third column, and a fourth group of data bits (6, 7) are stored in the fourth column.

The remaining three RAMs are configured to store three bit ECC codes 320 associated with groups of data bits (e.g., the columns of RAMs 0 and 1). The first ECC code, W0E0 through W0E2 (word 0, ECC bits 0 through 2) is distributed over the first column of RAMs 2 through 4 and is associated with data bits 0 and 1. Likewise, the second ECC code, W1E0-W1E2 is distributed over the second column of RAMs 2 through 4 and is associated with data bits 2 and 3. The third ECC code, W2E0-W2E2 is distributed over the third column of RAMs 2 through 4 and is associated with data bits 4 and 5. Lastly, the fourth ECC code, W3E0-W3E2 is distributed over the fourth column of RAMs 2 through 4 and is associated with data bits 6 and 7.

If an error occurs in any single bit of a group of data bits (the columns of the RAMs), that error can be corrected based on the ECC code associated with that data bit group. For example, if data bit 0 were corrupted, it could be restored based on ECC code W0. If an entire RAM were to be corrupted (e.g., a SEFI), all of the data bits in that RAM could be restored based on the ECC codes W0-W3. Likewise, a single data bit error in any or all of the groups of data bits (columns) can be corrected.

An overhead factor OF can be defined as the total number of RAMs employed by the memory unit divided by the number of RAMs used to store data. In this example case, for 8 bit data words, only two of the five RAMs are used to store data and thus the overhead factor OF=2.5, which is relatively inefficient. However, as the size of the data word increases, the efficiency also increases, as will be seen in the following cases.

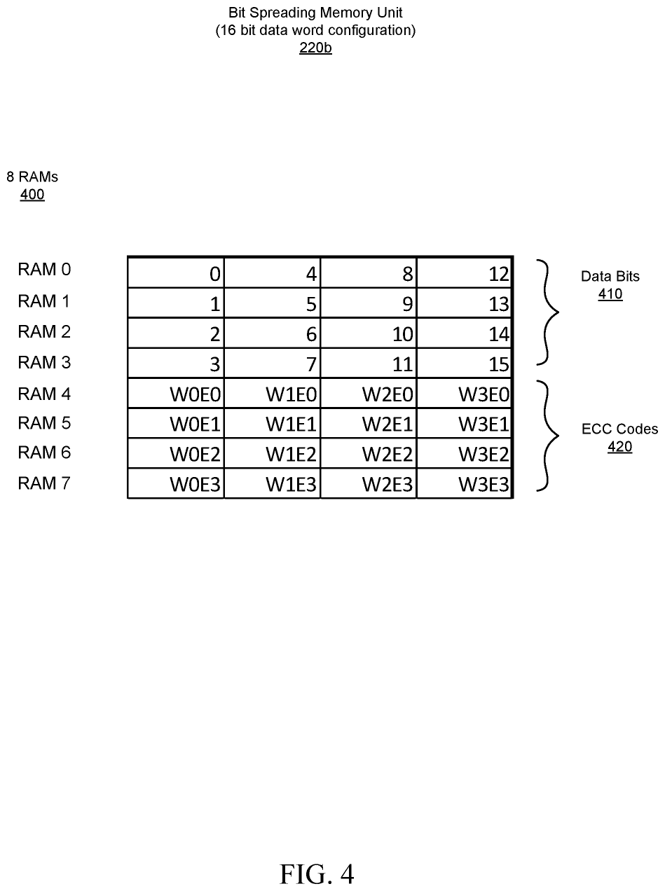

FIG. 4 is an illustration of a bit spreading memory unit 220b configured for 16 bit data words, in accordance with certain embodiments of the present disclosure. The memory unit 220b is shown to include eight RAMs 400, each configured to store four bits. The first four RAMs are configured to store the 16 data bits 410 of the data word written to the memory unit, as shown. In particular, a first group of data bits (0-3) are stored or distributed over RAMs 0-3 in the first column of the RAMs. Likewise, a second group of data bits (4-7) are stored in the second column, a third group of data bits (8-11) are stored in the third column, and a fourth group of data bits (12-15) are stored in the fourth column.

The remaining four RAMs are configured to store four bit ECC codes 420 associated with groups of data bits (e.g., the columns of RAMs 0-3). The first ECC code, W0E0 through W0E3 is distributed over the first column of RAMs 4-7 and is associated with data bits 0-3. Likewise, the second ECC code, W1E0-W1E3 is distributed over the second column of RAMs 4-7 and is associated with data bits 4-7. The third ECC code, W2E0-W2E3 is distributed over the third column of RAMs 4-7 and is associated with data bits 8-11. Lastly, the fourth ECC code, W3E0-W3E3 is distributed over the fourth column of RAMs 4-7 and is associated with data bits 12-15.

As previously described, in connection with the 8 bit data word configuration of FIG. 3, if an error occurs in any single bit of a group of data bits (e.g., the columns of the RAMs), that error can be corrected based on the ECC code associated with that data bit group.

In this example case, for 16 bit data words, four of the eight RAMs are used to store data and thus the overhead factor OF=2.0, which is an improvement over the 8 bit data word case described above.

FIG. 5 is an illustration of a bit spreading memory unit 220c configured for 32 bit data words, in accordance with certain embodiments of the present disclosure. The memory unit 220c is shown to include 13 RAMs 500, each configured to store four bits. The first eight RAMs are configured to store the 32 data bits 510 of the data word written to the memory unit, as shown. In particular, a first group of data bits (0-7) are stored or distributed over RAMs 0-7 in the first column of the RAMs. Likewise, a second group of data bits (8-15) are stored in the second column, a third group of data bits (16-23) are stored in the third column, and a fourth group of data bits (24-31) are stored in the fourth column.

The remaining five RAMs are configured to store five bit ECC codes 520 associated with groups of data bits (e.g., the columns of RAMs 0-7). The first ECC code, W0E0 through W0E4 is distributed over the first column of RAMs 8-12 and is associated with data bits 0-7. Likewise, the second ECC code, W1E0-W1E4 is distributed over the second column of RAMs 8-12 and is associated with data bits 8-15. The third ECC code, W2E0-W2E4 is distributed over the third column of RAMs 8-12 and is associated with data bits 16-23. Lastly, the fourth ECC code, W3E0-W3E4 is distributed over the fourth column of RAMs 8-12 and is associated with data bits 24-31. As previously described if an error occurs in any single bit of a group of data bits (the columns of the RAMs), that error can be corrected based on the ECC code associated with that data bit group.

In this example case, for 32 bit data words, eight of the 13 RAMs are used to store data and thus the efficiency overhead factor OF=1.625, which is a further improvement over the previously described cases.

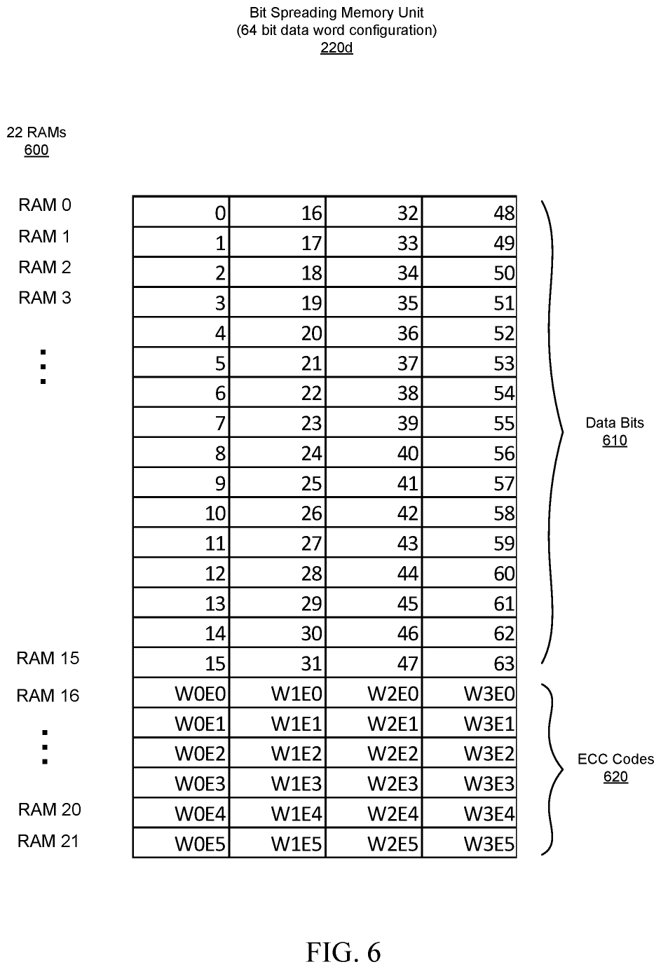

FIG. 6 is an illustration of a bit spreading memory unit 220d configured for 64 bit data words, in accordance with certain embodiments of the present disclosure. The memory unit 220d is shown to include 22 RAMs 600, each configured to store four bits. The first 16 RAMs are configured to store the 64 data bits 610 of the data word written to the memory unit, as shown. In particular, a first group of data bits (0-15) are stored or distributed over RAMs 0-15 in the first column of the RAMs. Likewise, a second group of data bits (16-31) are stored in the second column, a third group of data bits (32-47) are stored in the third column, and a fourth group of data bits (48-63) are stored in the fourth column.

The remaining six RAMs are configured to store six bit ECC codes 620 associated with groups of data bits (e.g., the columns of RAMs 0-15). The first ECC code, W0E0 through W0E5 is distributed over the first column of RAMs 16-21 and is associated with data bits 0-15. Likewise, the second ECC code, W1E0-W1E5 is distributed over the second column of RAMs 16-21 and is associated with data bits 16-31. The third ECC code, W2E0-W2E5 is distributed over the third column of RAMs 16-21 and is associated with data bits 32-47. Lastly, the fourth ECC code, W3E0-W3E5 is distributed over the fourth column of RAMs 16-21 and is associated with data bits 48-63. As previously described if an error occurs in any single bit of a group of data bits (the columns of the RAMs), that error can be corrected based on the ECC code associated with that data bit group.

In this example case, for 64 bit data words, 16 of the 22 RAMs are used to store data and thus the overhead factor OF=1.375, which is a further improvement over the previously described cases.

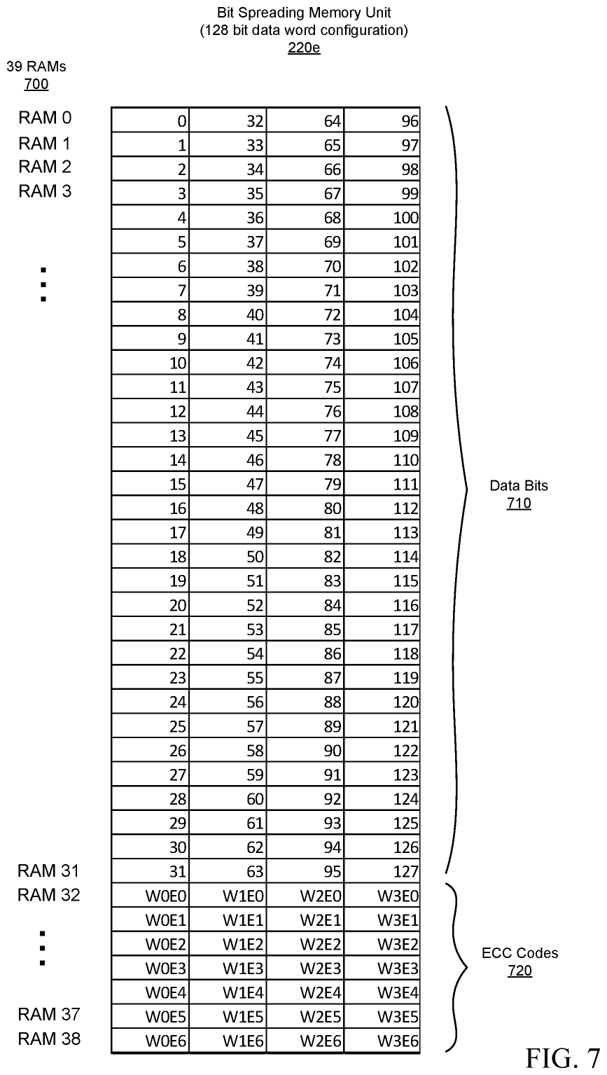

FIG. 7 is an illustration of a bit spreading memory unit 220e configured for 128 bit data words, in accordance with certain embodiments of the present disclosure. The memory unit 220e is shown to include 39 RAMs 700, each configured to store four bits. The first 32 RAMs are configured to store the 128 data bits 710 of the data word written to the memory unit, as shown. In particular, a first group of data bits (0-31) are stored or distributed over RAMs 0-31 in the first column of the RAMs. Likewise, a second group of data bits (32-63) are stored in the second column, a third group of data bits (64-95) are stored in the third column, and a fourth group of data bits (96-127) are stored in the fourth column.

The remaining seven RAMs are configured to store seven bit ECC codes 720 associated with groups of data bits (e.g., the columns of RAMs 0-31). The first ECC code, W0E0 through W0E6 is distributed over the first column of RAMs 32-38 and is associated with data bits 0-31. Likewise, the second ECC code, W1E0-W1E6 is distributed over the second column of RAMs 32-38 and is associated with data bits 32-63. The third ECC code, W2E0-W2E6 is distributed over the third column of RAMs 32-38 and is associated with data bits 64-95. Lastly, the fourth ECC code, W3E0-W3E6 is distributed over the fourth column of RAMs 32-38 and is associated with data bits 96-127. As previously described if an error occurs in any single bit of a group of data bits (the columns of the RAMs), that error can be corrected based on the ECC code associated with that data bit group.

In this example case, for 128 bit data words, 32 of the 39 RAMs are used to store data and thus the overhead factor OF=1.21875, which is a further improvement over the previously described cases.

It will be appreciated that other memory unit configurations are possible and can be adapted to any desired application. For example, the RAMs may be configured to store more than 4 bits of data, and the memory units may be configured for use with data words of different sizes.

### Methodology

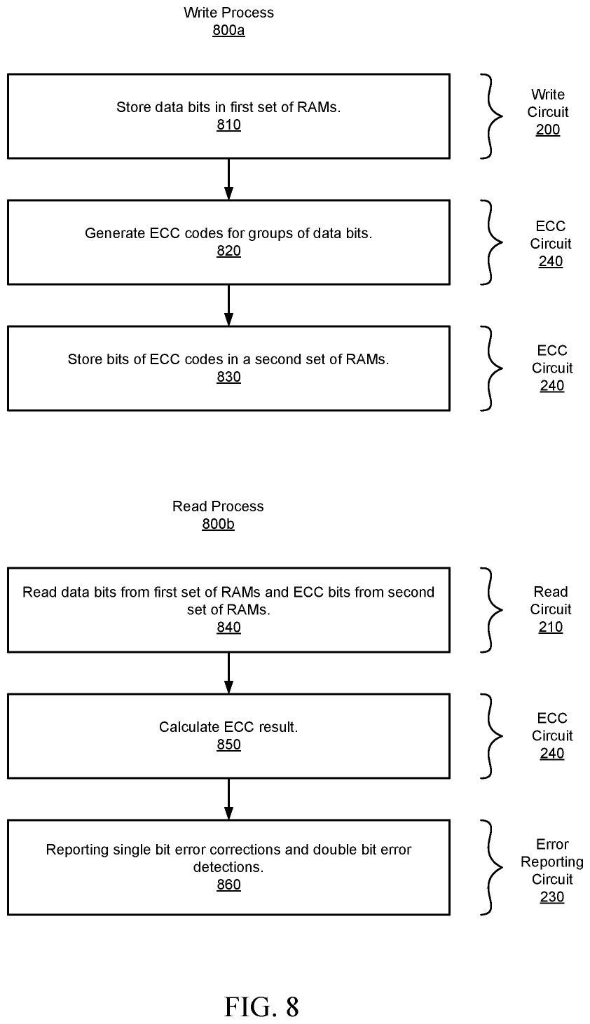

FIG. 8 is a flowchart illustrating a methodology 800 for providing radiation hardened error resistant memory, in accordance with an embodiment of the present disclosure. As can be seen, example method 800 includes a number of phases and sub-processes, the sequence of which may vary from one embodiment to another. However, when considered in aggregate, these phases and sub-processes form a process for providing radiation hardened memory error resistant memory, in accordance with certain of the embodiments disclosed herein, for example as illustrated in FIGS. 1-7, as described above. However other system architectures can be used in other embodiments, as will be apparent in light of this disclosure. To this end, the correlation of the various functions shown in FIG. 8 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 800 comprises a write process 800a and a read process 800b. In one embodiment, method 800a commences, at operation 810, by storing data bits written by a processor into a memory unit of the memory system. The stored data bits are distributed over a first plurality of RAMs of the memory unit, as previously described.

At operation 820, ECC codes are generated. Each of the ECC codes is associated with a unique group of the stored data bits. For example, a unique group of the stored data bits may be the columns across the first plurality of RAMs, as previously described. In some embodiments, the ECC codes are generated using a Hamming ECC coding technique, although any ECC code that is capable of correcting a single bit error can be used.

At operation 830, bits of the ECC codes are stored in a second plurality of RAMs of the memory unit such that the bits of the ECC codes are distributed over the second plurality of RAMs, as previously described. In some embodiments, operations 810 through 830 may occur in parallel.

In one embodiment, method 800b commences, at operation 840, by reading the stored data bits from the first plurality of RAMs of the memory unit and reading the ECC codes from the second plurality of RAMs, as previously described.

At operation 850, ECC codes are calculated for the data bits and verified against the ECC codes read from the second plurality of RAMs to potentially generate single bit error corrections and/or double bit error detections.

At operation 860, any single bit error corrections and/or double bit error detections are reported back to the processor.

### Example System

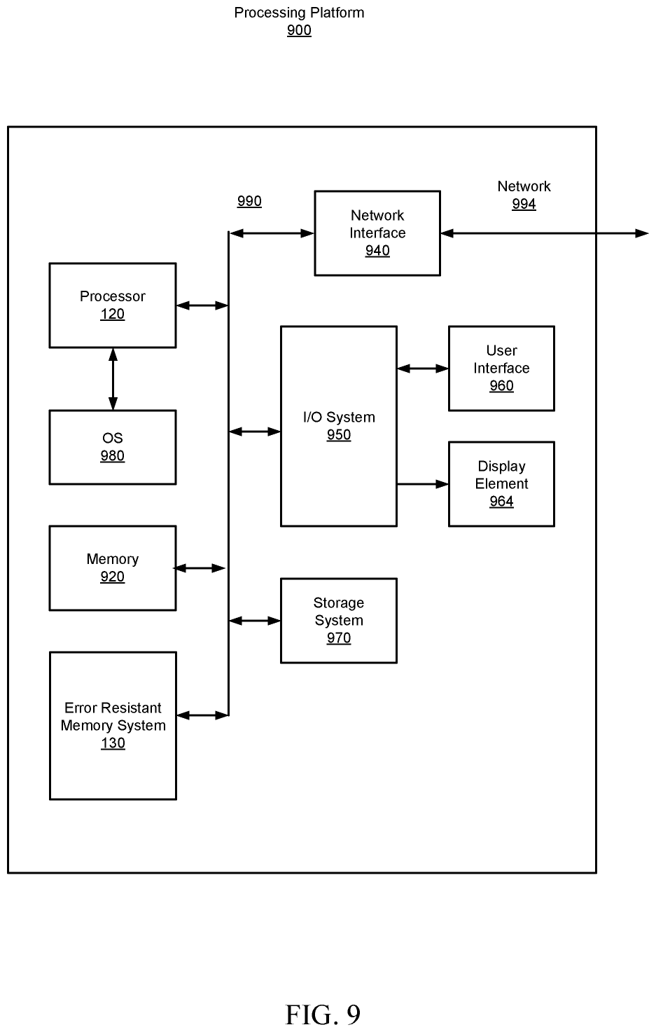

FIG. 9 is a block diagram of a processing platform 900 configured to provide radiation hardened error resistant memory, in accordance with an embodiment of the present disclosure. In some embodiments, platform 900, or portions thereof, may be hosted on, or otherwise be incorporated into the electronic systems of a space-based or aerospace platform, including data communications systems, radar systems, computing systems, or embedded systems of any sort, where radiation hardening is particularly useful, although other applications (including terrestrial applications) will be apparent. The disclosed techniques may also be used to improve memory reliability in other platforms including data communication devices, personal computers, workstations, laptop computers, tablets, touchpads, portable computers, handheld computers, cellular telephones, smartphones, or messaging devices. Any combination of different devices may be used in certain embodiments.

In some embodiments, platform 900 may comprise any combination of a processor 120, memory 920, error resistant memory system 130, a network interface 940, an input/output (I/O) system 950, a user interface 960, a display element 964, and a storage system 970. As can be further seen, a bus and/or interconnect 990 is also provided to allow for communication between the various components listed above and/or other components not shown. Platform 900 can be coupled to a network 994 through network interface 940 to allow for communications with other computing devices, platforms, devices to be controlled, or other resources. Other componentry and functionality not reflected in the block diagram of FIG. 9 will be apparent in light of this disclosure, and it will be appreciated that other embodiments are not limited to any particular hardware configuration.

Processor 120 can be any suitable processor, and may include one or more coprocessors or controllers, such as an audio processor, a graphics processing unit, or hardware accelerator, to assist in the execution of mission software and/or any control and processing operations associated with platform 900. In some embodiments, the processor 120 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 120 may be implemented as a complex instruction set computer (CISC) or a reduced instruction set computer (RISC) processor. In some embodiments, processor 120 may be configured as an x86 instruction set compatible processor.

Memory 920, which is not part of the error resistant memory system 130, can be implemented using any suitable type of digital storage including, for example, flash memory and/or random access memory (RAM). In some embodiments, the memory 920 may include various layers of memory hierarchy and/or memory caches as are known to those of skill in the art. Memory 920 may be implemented as a volatile memory device such as, but not limited to, a RAM, dynamic RAM (DRAM), or static RAM (SRAM) device. Storage system 970 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 120 may be configured to execute an Operating System (OS) 980 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 900, and therefore may also be implemented using any suitable existing or subsequently-developed platform.

Network interface circuit 940 can be any appropriate network chip or chipset which allows for wired and/or wireless connection between other components of platform 900 and/or network 994, thereby enabling platform 900 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 950 may be configured to interface between various I/O devices and other components of platform 900. I/O devices may include, but not be limited to, user interface 960 and display element 964. User interface 960 may include devices (not shown) such as a touchpad, keyboard, and mouse, etc., for example, to allow the user to control the system. Display element 964 may be configured to display information to a user. I/O system 950 may include a graphics subsystem configured to perform processing of images for rendering on the display element 964. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 120 or any chipset of platform 900.

It will be appreciated that in some embodiments, the various components of platform 900 may be combined or integrated in a system-on-a-chip (SoC) architecture. In some embodiments, the components may be hardware components, firmware components, software components or any suitable combination of hardware, firmware or software.

Error resistant memory system 130 is configured to provide radiation hardened reliability for memories using bit spreading techniques, as described previously. Error resistant memory system 130 may include any or all of the circuits/components illustrated in FIGS. 2-7, as described above. These components can be implemented or otherwise used in conjunction with a variety of suitable software and/or hardware that is coupled to or that otherwise forms a part of platform 900. These components can additionally or alternatively be implemented or otherwise used in conjunction with user I/O devices that are capable of providing information to, and receiving information and commands from, a user.

In various embodiments, platform 900 may be implemented as a wireless system, a wired system, or a combination of both. When implemented as a wireless system, platform 900 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 900 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other. Some embodiments may be described using the expression “each.” This term is not intended to be limited to “each and every.”

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 994. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 900 may comprise additional, fewer, or alternative subcomponents as compared to those included in the example embodiment of FIG. 9.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a memory unit comprising: a first plurality of random access memories (RAMs) configured to store data bits of a data word written to the memory unit, the data bits distributed over the first plurality of RAMs; and a second plurality of RAMs configured to store bits of ECC codes, each ECC code associated with a unique group of the data bits, such that the bits of each ECC code are distributed over the second plurality of RAMs.

Example 2 includes the memory unit of Example 1, wherein each of the RAMs of the first plurality of RAMs is configured to store four of the data bits, and each of the RAMs of the second plurality of RAMs is configured to store four bits of the ECC codes.

Example 3 includes the memory unit of Example 2, wherein the first plurality of RAMs comprises eight RAMs such that the memory unit is configured to store 32 of the data bits, and the second plurality of RAMs comprise five RAMs such that the memory unit is configured to store four ECC codes of length five bits.

Example 4 includes the memory unit of Example 2, wherein the first plurality of RAMs comprises 16 RAMs such that the memory unit is configured to store 64 of the data bits, and the second plurality of RAMs comprise six RAMs such that the memory unit is configured to store four ECC codes of length six bits.

Example 5 includes the memory unit of Example 2, wherein the first plurality of RAMs comprises 32 RAMs such that the memory unit is configured to store 128 of the data bits, and the second plurality of RAMs comprise seven RAMs such that the memory unit is configured to store four ECC codes of length seven bits.

Example 6 includes the memory unit of any of Examples 1-5, wherein the ECC codes are configured to detect and correct a single bit error in the group of data bits and to detect a double bit error in the group of data bits.

Example 7 includes the memory unit of any of Examples 1-5, further comprising a reporting circuit configured to report a single bit error correction or a double bit error detection, resulting from a read operation on the memory unit.

Example 8 includes the memory unit of any of Examples 1-5, wherein the ECC codes are Hamming codes.

Example 9 includes the memory unit of any of Examples 1-5, wherein the ECC codes are of length log 2(N)+2 bits, where N is the number of bits in the group of the data bits.

Example 10 is an error resistant memory system comprising one or more of the memory units of Example 1.

Example 11 is a processing system comprising: At least one processor configured to execute mission software; and an error resistant memory system coupled to the processor and comprising one or more memory units, the memory units configured to store a data word written by the processor to the memory system, the memory units comprising: a first plurality of random access memories (RAMs) configured to store data bits of the data word, the data bits distributed over the first plurality of RAMs; and a second plurality of RAMs configured to store bits of ECC codes, each ECC code associated with a unique group of the data bits, such that the bits of each ECC code are distributed over the second plurality of RAMs.

Example 12 includes the processing system of Example 11, wherein each of the RAMs of the first plurality of RAMs is configured to store four of the data bits, and each of the RAMs of the second plurality of RAMs is configured to store four bits of the ECC codes.

Example 13 includes the processing system of Example 12, wherein the first plurality of RAMs comprises eight RAMs such that the memory unit is configured to store 32 of the data bits, and the second plurality of RAMs comprise five RAMs such that the memory unit is configured to store four ECC codes of length five bits.

Example 14 includes the processing system of Example 12, wherein the first plurality of RAMs comprises 16 RAMs such that the memory unit is configured to store 64 of the data bits, and the second plurality of RAMs comprise six RAMs such that the memory unit is configured to store four ECC codes of length six bits.

Example 15 includes the processing system of Example 12, wherein the first plurality of RAMs comprises 32 RAMs such that the memory unit is configured to store 128 of the data bits, and the second plurality of RAMs comprise seven RAMs such that the memory unit is configured to store four ECC codes of length seven bits.

Example 16 includes the processing system of any of Examples 11-15, wherein the error resistant memory system further comprises a reporting circuit configured to report, to the processor, a single bit error correction or a double bit error detection, resulting from a read operation on the memory unit.

Example 17 is a method for providing radiation hardened memory, the method comprising: storing data bits in a first plurality of random access memories (RAMs) of a memory unit, the data bits distributed over the first plurality of RAMs; generating error correction codes (ECC codes), each of the ECC codes associated with a unique group of the data bits; and storing bits of the ECC codes in a second plurality of RAMs of the memory unit such that the bits of the ECC codes are distributed over the second plurality of RAMs.

Example 18 includes the method of Example 17, wherein each of the RAMs of the first plurality of RAMs is configured to store four data bits, and each of the RAMs of the second plurality of RAMs is configured to store four bits of the ECC codes.

Example 19 includes the method of Example 18, wherein the first plurality of RAMs comprises eight RAMs such that the memory unit is configured to store 32 of the data bits, and the second plurality of RAMs comprise five RAMs such that the memory unit is configured to store four ECC codes of length five bits.

Example 20 includes the method of any of Examples 17-19, wherein the ECC codes are configured to detect and correct a single bit error in the group of data bits and to detect a double bit error in the group of data bits, and the method further comprises reporting a single bit error correction or a double bit error detection, resulting from a read operation on the memory unit.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A memory unit comprising:
a first plurality of random access memories (RAMs) configured to store data bits of a data word written to the memory unit, the data bits distributed over the first plurality of RAMs; and
a second plurality of RAMs configured to store bits of ECC codes, each ECC code associated with a unique group of the data bits, such that the bits of each ECC code are distributed over the second plurality of RAMs.

2. The memory unit of claim 1, wherein each of the RAMs of the first plurality of RAMs is configured to store four of the data bits, and each of the RAMs of the second plurality of RAMs is configured to store four bits of the ECC codes.

3. The memory unit of claim 2, wherein the first plurality of RAMs comprises eight RAMs such that the memory unit is configured to store 32 of the data bits, and the second plurality of RAMs comprise five RAMs such that the memory unit is configured to store four ECC codes of length five bits.

4. The memory unit of claim 2, wherein the first plurality of RAMs comprises 16 RAMs such that the memory unit is configured to store 64 of the data bits, and the second plurality of RAMs comprise six RAMs such that the memory unit is configured to store four ECC codes of length six bits.

5. The memory unit of claim 2, wherein the first plurality of RAMs comprises 32 RAMs such that the memory unit is configured to store 128 of the data bits, and the second plurality of RAMs comprise seven RAMs such that the memory unit is configured to store four ECC codes of length seven bits.

6. The memory unit of claim 1, wherein the ECC codes are configured to detect and correct a single bit error in the group of data bits and to detect a double bit error in the group of data bits.

7. The memory unit of claim 1, further comprising a reporting circuit configured to report a single bit error correction or a double bit error detection, resulting from a read operation on the memory unit.

8. The memory unit of claim 1, wherein the ECC codes are Hamming codes.

9. The memory unit of claim 1, wherein the ECC codes are of length log₂(N)+2 bits, where N is the number of bits in the group of the data bits.

10. An error resistant memory system comprising one or more of the memory units of claim 1.

11. A processing system comprising:
at least one processor configured to execute mission software; and
an error resistant memory system coupled to the processor and comprising one or more memory units, the memory units configured to store a data word written by the processor to the memory system, the memory units comprising:
a first plurality of random access memories (RAMs) configured to store data bits of the data word, the data bits distributed over the first plurality of RAMs; and
a second plurality of RAMs configured to store bits of ECC codes, each ECC code associated with a unique group of the data bits, such that the bits of each ECC code are distributed over the second plurality of RAMs.

12. The processing system of claim 11, wherein each of the RAMs of the first plurality of RAMs is configured to store four of the data bits, and each of the RAMs of the second plurality of RAMs is configured to store four bits of the ECC codes.

13. The processing system of claim 12, wherein the first plurality of RAMs comprises eight RAMs such that the memory unit is configured to store 32 of the data bits, and the second plurality of RAMs comprise five RAMs such that the memory unit is configured to store four ECC codes of length five bits.

14. The processing system of claim 12, wherein the first plurality of RAMs comprises 16 RAMs such that the memory unit is configured to store 64 of the data bits, and the second plurality of RAMs comprise six RAMs such that the memory unit is configured to store four ECC codes of length six bits.

15. The processing system of claim 12, wherein the first plurality of RAMs comprises 32 RAMs such that the memory unit is configured to store 128 of the data bits, and the second plurality of RAMs comprise seven RAMs such that the memory unit is configured to store four ECC codes of length seven bits.

16. The processing system of claim 11, wherein the error resistant memory system further comprises a reporting circuit configured to report, to the processor, a single bit error correction or a double bit error detection, resulting from a read operation on the memory unit.

17. A method for providing radiation hardened memory, the method comprising:
storing data bits in a first plurality of random access memories (RAMs) of a memory unit, the data bits distributed over the first plurality of RAMs;
generating error correction codes (ECC codes), each of the ECC codes associated with a unique group of the data bits; and
storing bits of the ECC codes in a second plurality of RAMs of the memory unit such that the bits of the ECC codes are distributed over the second plurality of RAMs.

18. The method of claim 17, wherein each of the RAMs of the first plurality of RAMs is configured to store four data bits, and each of the RAMs of the second plurality of RAMs is configured to store four bits of the ECC codes.

19. The method of claim 18, wherein the first plurality of RAMs comprises eight RAMs such that the memory unit is configured to store 32 of the data bits, and the second plurality of RAMs comprise five RAMs such that the memory unit is configured to store four ECC codes of length five bits.

20. The method of claim 17, wherein the ECC codes are configured to detect and correct a single bit error in the group of data bits and to detect a double bit error in the group of data bits, and the method further comprises reporting a single bit error correction or a double bit error detection, resulting from a read operation on the memory unit.
